(19) United States
(12) Patent Application Publication
(10) Pub. No.: US 2026/0133695 A1
(43) Pub. Date: May 14, 2026

(54) Optimized KV Metadata Storage for Machine Learning Applications

(71) Applicant: Sandisk Technologies, Inc., Milpitas, CA (US)

(72) Inventors: Alexander BAZARSKY, Holon (IL); David AVRAHAM, Even Yehuda (IL); Ran ZAMIR, Ramat Gan (IL)

(73) Assignee: Sandisk Technologies, Inc., Milpitas, CA (US)

(21) Appl. No.: 18/945,856

(22) Filed: Nov. 13, 2024

(51) Int. Cl. G06F 3/06; G06F 16/16

(52) U.S. Cl. CPC G06F 3/0611; G06F 3/0638; G06F 3/0658; G06F 3/0688; G06F 16/164

(57) ABSTRACT

Metadata that is generated during the life of machine learning and artificial intelligence systems are valuable. However, such metadata may be generated subsequent to the time of the data generation, and thus written to the storage device later. By further supporting KV databases on the storage device level, performance may be increased in terms of transfers per second. This is due to the removal of the translation layer in the host, which was previously required for data storage. The removal of the translation layer provides for the removal of two layers of mapping and transaction information. As a result, the number of transactions per second, write amplification, and read amplification increase, while latency decreases. Additionally, future additions of metadata are considered by reserving excess memory at the time of storing the start key value. The future additions are then saved to the reserved memory later.

### BACKGROUND OF THE DISCLOSURE

### Field of the Disclosure

Embodiments of the present disclosure generally relate to data storage devices, such as solid state drives (SSDs), and, more specifically, optimizing storage of a key value pair data and associated metadata in a data storage device.

### Description of the Related Art

A key value (KV) database works by storing a quantity of user data that is associated with a key that is addressable as a complete entity. Examples of user data that can be stored in a KV database may include photos, records, and files. From a host device point-of-view, the photo, the record, or the file may be retrieved using a single key/address, rather than using multiple addresses that include data of the photo, the record, or the file. The data is stored as unstructured data and may be addressed using a key of variable length. Storage space of a memory device may be allocated for KV pair data in increments of bytes, where a length value of the KV pair data is associated with the necessary storage space to store the KV pair data.

Using a KV database in a data storage device may increase the performance of the data storage device. For example, the number of data transfers/second may be improved because the KV pair data to physical storage location translation layer in the host device may be removed. Furthermore, the number of commands over the bus may be reduced since an entire KV pair data may utilize a single transfer. However, metadata associated with the KV pair data may not be available for storage in the data storage device when the KV pair data is transferred to the data storage device. In other words, the metadata associated with the KV pair data may be generated after the KV pair data is programmed to the data storage device. When the metadata is transferred non-concurrently with the associated KV pair data, additional mappings are needed to address the metadata as well as associating the metadata to the KV pair data, which may increase latency when processing commands related to the KV pair data and associated metadata as well as require additional memory to store the additional mappings.

There is a need in the art for an optimized storage of mappings for KV pair data and associated metadata.

### SUMMARY OF THE DISCLOSURE

Metadata that is generated during the life of machine learning and artificial intelligence systems is valuable. However, such metadata may be generated subsequent to the time of the data generation, and thus written to the storage device later. By further supporting KV databases on the storage device level, performance may be increased in terms of transfers per second. This is due to the removal of the translation layer in the host, which was previously required for data storage. The removal of the translation layer provides for the removal of two layers of mapping and transaction information. As a result, the number of transactions per second, write amplification, and read amplification increase, while latency decreases. Additionally, future additions of metadata are considered by reserving excess memory at the time of storing the start key value. The future additions are then saved to the reserved memory later.

In one embodiment, a data storage device includes a memory device; and a controller coupled to the memory device, wherein the controller is configured to: receive data from a host, wherein the data is key value (KV) pair data; store the data to a KV namespace, wherein: the KV namespace comprises a key and a value; the key addresses the value; the value comprises a plurality of flash management units (FMUs); receive a write command from the host to write a second data to the KV namespace, wherein the write command to write metadata is received subsequent to receipt of the KV pair data; and store the second data to the KV namespace.

In another embodiment, a data storage device includes a memory device; and a controller coupled to the memory device, wherein the controller is configured to: receive key value (KV) pair data from a host, wherein: the KV pair data comprises a key and a value; the key addresses the value; the value comprises a plurality of flash management units (FMUs); create a KV namespace, wherein the KV namespace comprises a key and a value; store the KV pair data to the KV namespace; receive a write command from the host to write metadata to the KV namespace, wherein the write command to write metadata is received subsequent to receipt of the KV pair data; and store the metadata to the KV namespace.

In yet another embodiment, a data storage device includes means to store data; and a controller coupled to the means to store data, wherein the controller comprises: a metadata translation module configured to translate metadata; and a flash translation layer communicatively coupled to the metadata translation module, and configured to translate KV values or logical block address into physical block addresses; the controller is configured to: receive key value (KV) pair data from a host, wherein: the KV pair data comprises a key and a value; the key addresses the value; the value comprises a plurality of flash management units (FMUs); create a KV namespace, wherein the KV namespace comprises a key and a value; store the KV pair data to the KV namespace; receive a write command from the host to write metadata to the KV namespace, wherein the write command to write metadata is received subsequent to receipt of the KV pair data; store the metadata to the KV namespace; and reserve a portion of the value of the KV namespace for storing metadata, wherein the portion is a remainder of the value of the KV namespace after storing the KV pair data to the KV namespace.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is an illustration of traditional KV storage and KV stacks, according to certain embodiments.

FIG. 3A is an exemplary illustration of a KV pair data, according to certain embodiments.

FIG. 3B is a table illustrating a command set for a KV database, according to certain embodiments.

FIG. 4 is a schematic block diagram illustrating a storage system, according to certain embodiments.

FIG. 5 is a flowchart illustrating a method of a KV metadata storage system, according to certain embodiments.

FIG. 6 is a flowchart illustrating a method of a KV metadata storage system, according to certain embodiments.

FIG. 7 is a flowchart illustrating a method of a KV metadata storage system, according to certain embodiments.

FIG. 8 is a flowchart illustrating a method of a KV metadata storage system, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Metadata that is generated during the life of machine learning and artificial intelligence systems are valuable. However, such metadata may be generated subsequent to the time of the data generation, and thus written to the storage device later. By further supporting KV databases on the storage device level, performance may be increased in terms of transfers per second. This is due to the removal of the translation layer in the host, which was previously required for data storage. The removal of the translation layer provides for the removal of two layers of mapping and transaction information. As a result, the number of transactions per second increases, while write amplification, read amplification and latency decrease. Additionally, future additions of metadata are considered by reserving excess memory at the time of storing the start key value. The future additions are then saved to the reserved memory later.

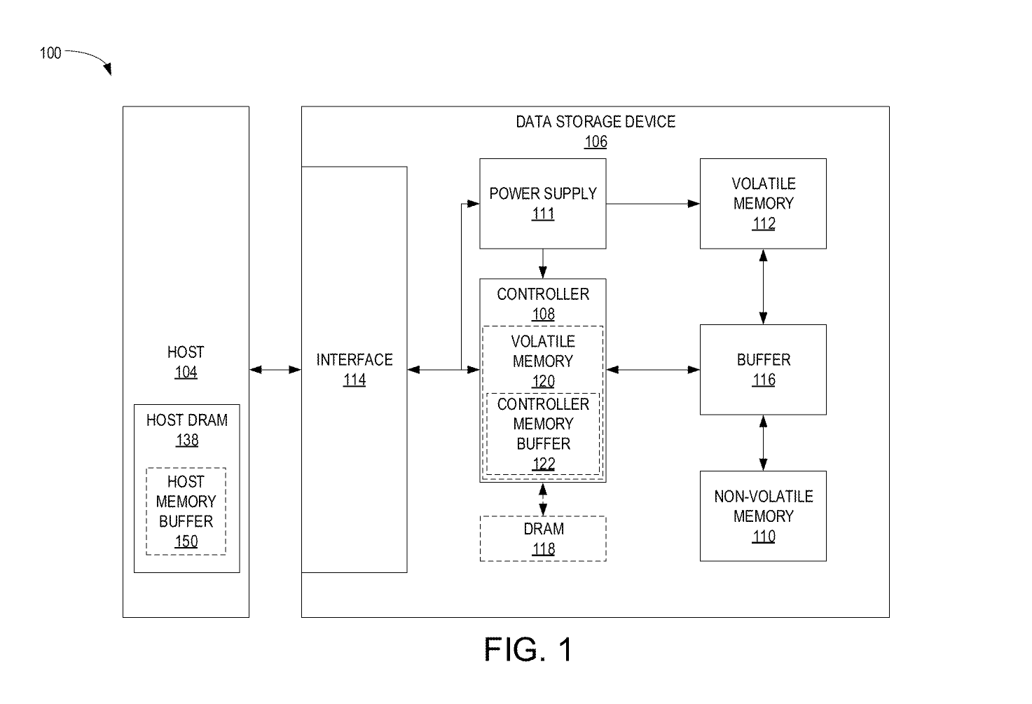

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with non-volatile memory express (NVMe) protocol or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

One of the promising new areas of industry development are SSDs supporting KV databases. NVMe standard version 2.0 introduced a dedicated application programming interface (API) for supporting these databases at the storage device level.

A KV database works by storing a quantity of user data that is associated with a key that is addressable as a complete entity. For example, a photo, a record, or a file. From the host point-of-view, the photo or the file can be retrieved using a single key-address rather than multiple addresses containing the data that makes up the photo. This can potentially abstract and simplify database management for certain applications, which results in advantages in the performance of these applications.

The following are examples of the main differences between normal block storage versus KV storage and the software stack to support it. In block storage, data is stored in blocks of a fixed size, data is addressed by a logical block address (LBA), the LBA is a fixed number of bytes, storage space is allocated in integer multiples of block size, and logical blocks are associated one-to-one with physical blocks. Whereas, in KV storage, data is stored as unstructured data, data is addressed by a key, a key is variable in length, storage space is allocated in increments of bytes, and the value is associated with amount of physical storage necessary. Indeed, there are many KV applications implemented in software on normal I/O storage devices.

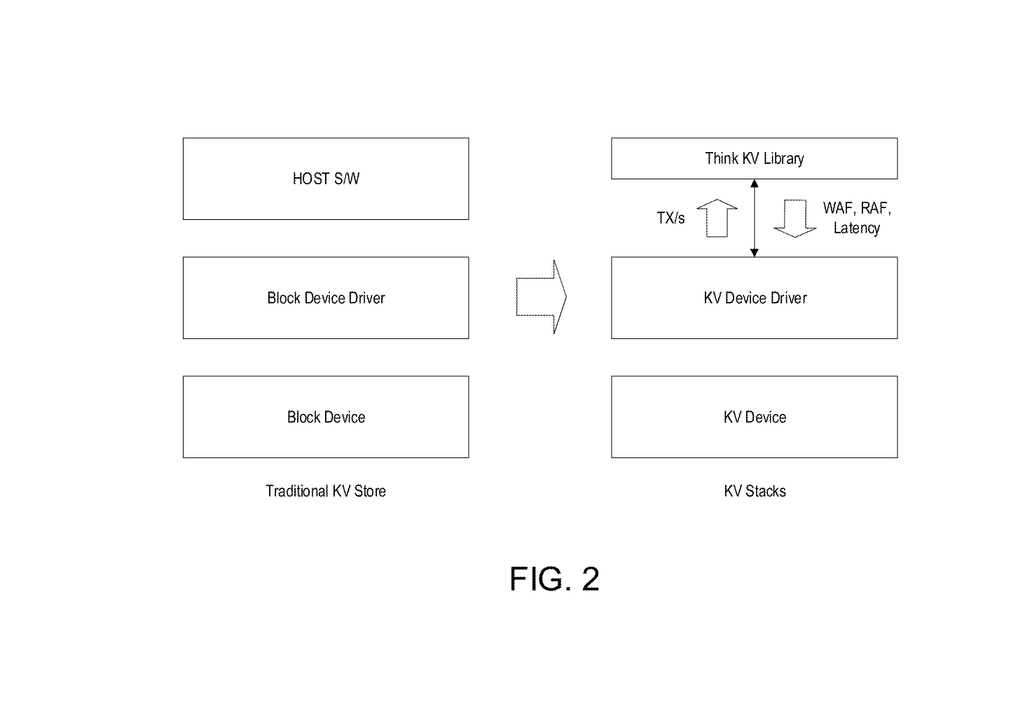

FIG. 2 is an illustration of traditional KV storage and KV stacks, according to certain embodiments. KV format and KV storage is often used by software (e.g., Java, Python). However, when host software data is stored in the non-volatile memory of data storage device (e.g., SSDs) the data is converted, via a translation layer of the host, to LBAs and physical block addresses (PBAs).

Thus, an advantage of supporting a KV database on the storage device level increases transfers per second performance. The performance increase occurs because the translation layer in the host from KV to block storage is removed. As a result, this removes two layers of mapping and transaction information, which increases the number of transactions per second and the write amplification while reducing latency. Additionally, the commands over the bus are reduced to a single transfer for the entire KV pair. Although, the reduction to a single transfer for the entire KV pair presents a second latency reduction, it is less significant than the savings from removing translation operations that must happen in the host. Another advantage of supporting a KV database on the storage device level is the simplification and enablement of computational storage (e.g., near storage compute). The user data on the device is now identifiable as a complete unit as opposed to various pieces that may or may not be contiguous in a normal storage operation.

As shown in FIG. 2, a traditional KV store includes Host S/W, block device driver, and the block device. The traditional KV store includes a translation layer in the host that converts KV pairs to LBAs and PBAs when storing to a data storage device. However, support of a KV database, such as in a KV stack, exhibits a complete unit and, in some embodiments, includes a thin KV library, a KV device driver, and a KV device. The removal of the translation layer, such as that present in a traditional KV store, results in an increase in performance (e.g., transactions per second (TX/s), and a deduction in the write amplification factor (WAF) and read amplification factor (RAF), and latency.

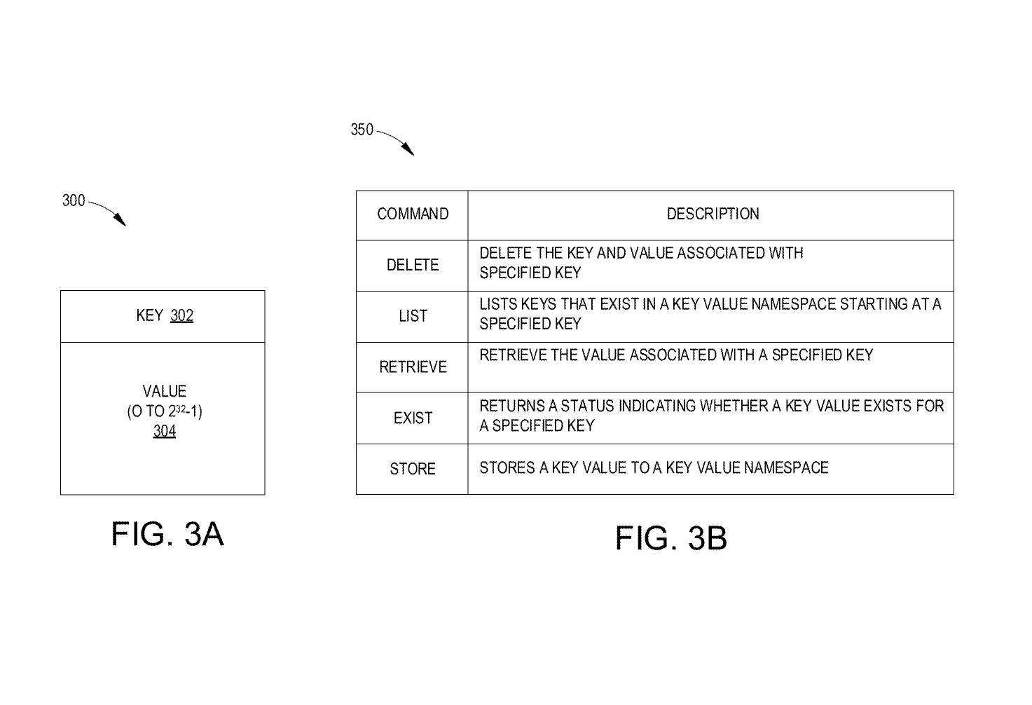

FIG. 3A is an exemplary illustration of a KV pair data 300, according to certain embodiments. KV pair data 300 includes a key 302 and a value 304, where the data, which may be host data, of the value 304 is addressed by the key 302. The key 302 may have a size of about 1 byte to about 64 bytes and the value 304 may have a size of about 0 bytes to about 2³²-1 bytes. For example, when the value 304 has a size of about 0 bytes, the value 304 is an empty value. It is to be understood that the previously mentioned values are not intended to be limiting, but to provide an example of an embodiment. Because the value 304 may have a size greater than a physical wordline (e.g., greater than 16KB), the value 304 may be divided across several wordlines and may result in misalignment. Misalignment may occur when partial data from multiple values are stored in a single wordline or when a portion of the value 304 is stored partially on a single wordline. Because misalignment of stored data may result in multiple reads, quality of service of a data storage device storing the misaligned data may be decreased and power consumption of the data storage device may be increased.

FIG. 3B is a table 350 illustrating a command set for a KV database, according to certain embodiments. For exemplary purposes, aspects of the storage system 100 of FIG. 1 may be referenced herein. A KV system may include a command set that includes, in a non-limiting list, a delete command, a list command, a retrieve command, an exist command, and a store command. The delete command may cause the controller 108 to delete the key 302 and value 304 associated with the key 302. The list command may cause the controller 108 to list keys that exist in a KV namespace starting at a specified key. The exist command may cause the controller 108 to return a status indicating whether a KV pair data 300 exists for a specified key to the command generator, such as the host device 104. The store command may cause the controller 108 to store a KV pair data to a KV namespace. The retrieve command may cause the controller 108 to retrieve the value 304 associated with a specified key from a KV namespace. The length to be retrieved of the KV pair data 300 is specified in the retrieve command and the location to transfer the KV pair data 300 is specified by either a scatter gather list (SGL) pointer or a physical region page (PRP) pointer in the retrieve command. If the specified length in the retrieve command is less than the length of the KV pair data 300 that is being retrieved, then the controller 108 returns the requested amount and the length of the KV pair data 300 to the completion queue. However, if the specified length in the retrieve command is greater than the length of the KV pair data 300 that is being retrieved, then the controller 108 returns the data from the NVM 110 and the length of the KV pair data 300 is returned to the completion queue.

Thus, by abstracting database management and storage devices (e.g., SSDs), KV SSDs allow for potential advantages in optimizations, simplifications, and improvements in both the host and the SSD due to the unique structure of KV SSDs. Currently, there is ongoing development of SSDs that present a KV database interface instead of a traditional block device. Adding a KV database interface to SSDs adds only a little bit of complexity to the SSD’s flash translation layer, while cutting out many redundant abstractions on the host software side. As a result, performance can be surprisingly high compared to running a KV database application on top of a file system on a traditional SSD.

The NVMe Key Value (NVMe-KV) Command Set has been standardized as one of the new I/O Command Sets that the NVM Express® Base Specification supports. NVMe-KV allows access to data on an NVMe SSD controller using a key rather than a block address. The NVMe-KV Command Set provides the key to store a corresponding value on non-volatile media, and then retrieves that value from the media by specifying the corresponding key. NVMe-KV allows users to access KV data without the costly and time-consuming overhead of additional translation tables between keys and logical blocks.

Traditional flash memory operates in 4KB chunks called flash management units (FMUs). This is the basic addressable unit for reading and writing. While not limited to this size, the size can range from 4Bs to 4GBs. For some applications, large values are used, and storing them in flash memory hold significant benefits. For some machine learning (ML) and artificial intelligence (AI) applications, metadata that is generated during the life of systems are valuable. However, the metadata may be generated later than the data generation time, and so will be written to the storage later. In some situations, there may also be several metadata pieces written at different times. Further, when using the data later, is it also beneficial to using the set of metadata that relates to it.

Previously, there was no mechanism to add metadata efficiently to data after it was written. Metadata is written like regular data, and connected to the content at the host level. A naïve KV storage system that adds metadata to a key, may read the value information that is associated with the key. Then, the KV storage system adds the metadata information to the value, and writes the entire value again. Or, in some cases, modifies the value. This approach is inefficient, as the host needs to read the entire value associated with the metadata, even though the host only wants to add to it. Alternatively, another naïve system would just write metadata to a new key and use the host resources to associate between the new and old keys. However, there is overhead associated with the fact that more keys are used unnecessarily, and the host needs to manage their storage.

An optimized way to store the metadata in a KV storage system is further discussed below. The associated apparatus and method are such that the metadata can be easily read together with the original data, thus improving the performance of the system.

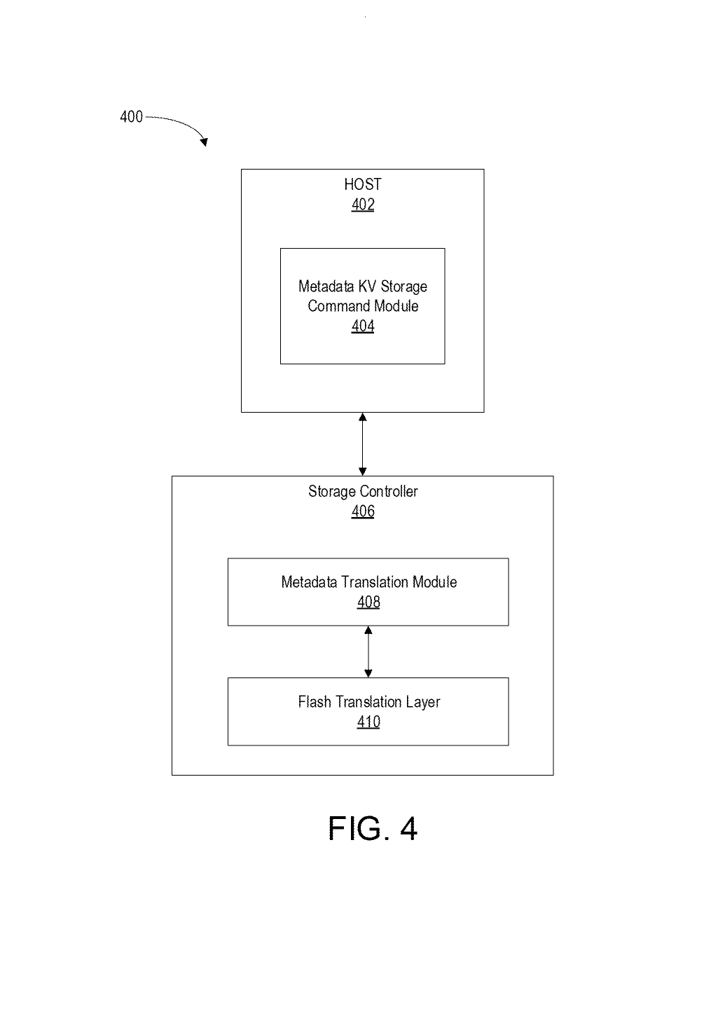

FIG. 4 is a schematic block diagram illustrating a storage system 400, according to certain embodiments. Storage system 400 is configured to store metadata for KV storage, and includes a host 402 and a storage controller 406. The host 402 and the storage controller 406 are communicatively coupled. Host 402 includes a metadata KV storage command module 404, while storage controller 406 includes a metadata translation module 408 and a flash translation layer 410. Storage system 400 may be an implementation of storage system 100 of FIG. 1 according to one or more embodiments, and may be combined with other embodiments. Host 402 may be the host 104 of FIG. 1. Storage controller 406 may be the controller 108 of FIG. 1. In some embodiments, the storage system 400 may use a dedicated API between the host and device. In some embodiments, the dedicated API of storage system 400 may be used in application associated with ML training and inference, based on metadata gathering and processing.

The metadata KV storage command module 404 is configured to indicate to the controller 406 that the module 404 passes metadata associated with a certain key (e.g., operations 502 and 602). Metadata translation module 408 is configured to determine whether there is sufficient space in the corresponding value for the metadata or key-value pair (e.g., operations 504 and 604). The flash translation layer 410 is communicatively coupled to the metadata translation module 408 and acts as the intermediary between the host and the storage device (e.g., the SSD). The flash translation layer 410 is configured to translate either KV values or LBAs used by the host into PBAs in the storage device during data storage. The flash translation layer 410 is further configured to read, modify, and write any corresponding values (e.g., operations 506, 606), as well as create and link any new keys to the data key internally (e.g., operations 508, 510, 608, 610).

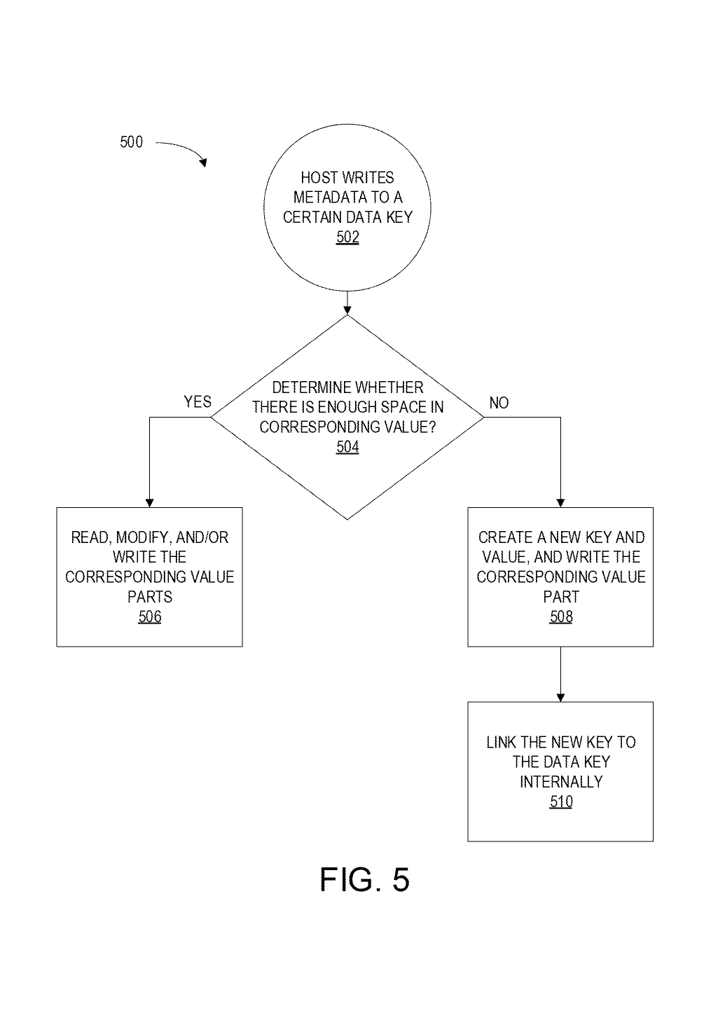

FIG. 5 is a flowchart illustrating a method 500 of a KV metadata storage system, according to certain embodiments. Method 500 creates values that considers the possibility of future addition of metadata. For example, if the information about the user takes 10KB, the value itself may contain 100KB. The start of the value will contain the 10KB of the sources information, but the rest of the value will be reserved for future metadata additions. In some embodiments, there may be a special command to add metadata to a specific key.

In some embodiments, metadata can be generated or gathered by the host after the data itself was already stored in the device. For example, in a recommendation system, the data can be a log entry of a user’s location at a certain time. The metadata can consist of the user being associated with a certain activity (inferred from the hosts’ other interests or applications)—for example, playing basketball. The system can then better recommend certain activities at locations in the future for this user.

Method 500 starts at operation 502, where a controller (e.g., the controller 406 of FIG. 4) receives a write command from a host (e.g., the host 402 of FIG. 4) to write metadata to a certain data key. At operation 504, the controller determines if there is sufficient space in the corresponding value to append the new piece of metadata. If so, then at operation 506, the controller may read, modify, or write the value internally to non-volatile memory (e.g., non-volatile memory 110 of FIG. 1). It is to be noted that not the entire value needs to be read, but only the part that is to be modified. If there is insufficient space in the corresponding value to append the new piece of metadata, then at operation 508, the controller creates a new key and value, and writes the corresponding value part. At operation 510, the controller internally links the new key to the original data key to which the new key was supposed to be appended to if there was sufficient space in the value. In some embodiments, the described link is transparent to the host. That is, the host does not know that the described link is stored jointly or disjointly from the data value itself.

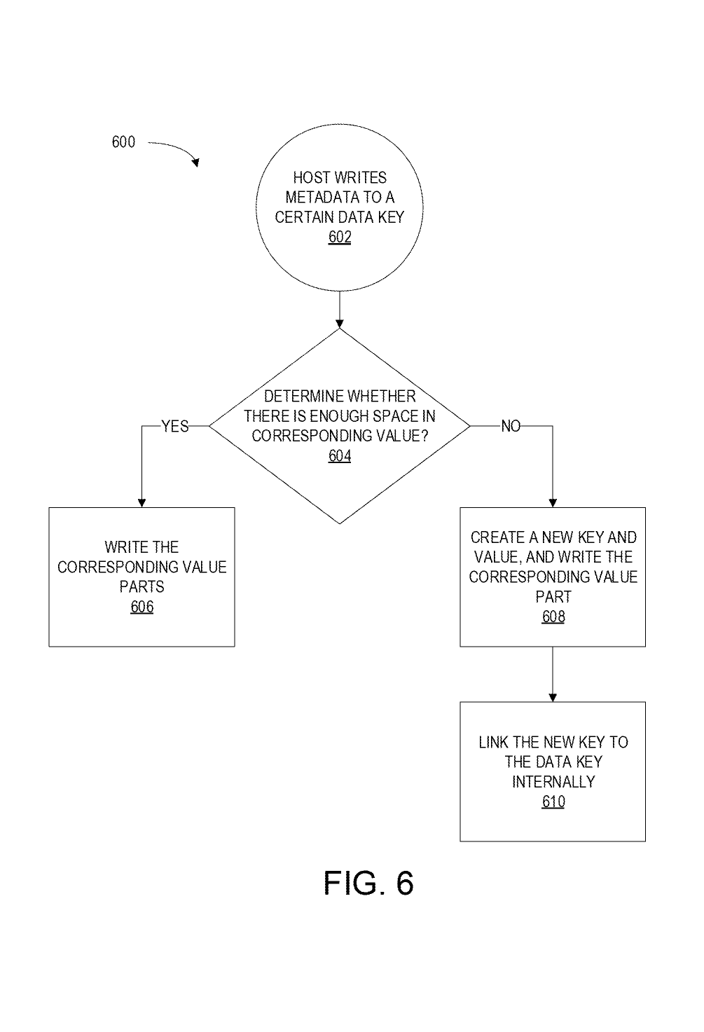

FIG. 6 is a flowchart illustrating a method 600 of a KV metadata storage system, according to certain embodiments. In the KV metadata storage system of method 600, the write granularity is of a full FMU. This can be controlled by either the host writing to the full FMUs, or the device pads the missing data parts before writing it in FMU granularity. In this scenario, there is no need to read and modify the corresponding value parts, and the controller can just write the corresponding empty value parts.

Method 600 starts at operation 602, where a controller (e.g., the controller 406 of FIG. 4) receives a write command from a host (e.g., the host 402 of FIG. 4) to write metadata to a certain data key. At operation 604, the controller determines if there is sufficient space in the corresponding value to append the new piece of metadata. If so, then at operation 606, the controller may write the value internally to non-volatile memory (e.g., non-volatile memory 110 of FIG. 1). It is to be noted that not the entire value needs to be read, but only the part that is to be modified. If there is insufficient space in the corresponding value to append the new piece of metadata, then at operation 608, the controller creates a new key and value, and writes the corresponding value part. At operation 610, the controller internally links the new key to the original data key to which the new key was supposed to be appended to if there was sufficient space in the value.

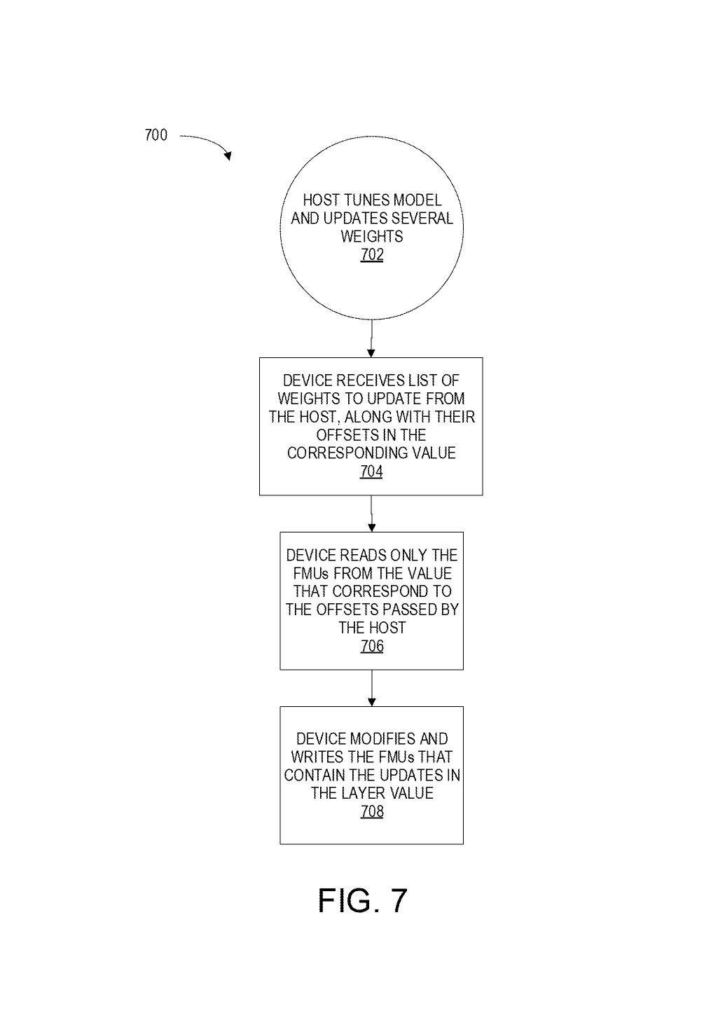

FIG. 7 is a flowchart illustrating a method 700 of a KV metadata storage system, according to certain embodiments. Sometimes, the source data may be disjointed from the metadata. As “values” are required to be read from their start, having the value start from the source data may incur unnecessary read data if the host only needs the metadata information. When reading, modifying, and/or rewriting the metadata value, a controller of the data storage device (e.g. controller 406 of FIG. 4) may decide to reorder the value. A host (e.g., the host 402 of FIG. 4) can indicate that it only wants a certain portion of the value so that the controller can stop reading once the controller has read the metadata that the host wants. For example, the value may be ordered such that the most recent metadata is written first, which has the highest chance of being read by the host.

Method 700 can be applied in ML models. For example, in embodiments where an entire model is written in a single value, or in several values, according to logical allocation, such as a value per layer of NN weights. There is an advantage in lowering the overhead for inference since models are often read sequentially in the inference step. Method 700 optimizes training and tuning when applied in ML models. When training ML and AI models, the weights may change often. However, in the later stages of training and when tuning the last layers of the model, only a sub-set of the weights may change. During such ML application of method 700, if the host (e.g., the host 402 of FIG. 4) is looking to update some of the weights, a controller (e.g. controller 406 of FIG. 4) may pass the weights that the controller wants to change and their model components (e.g., offsets) in the corresponding layer value. Model components (e.g., offsets) are associated with representations of the weights of a model. It is to be noted that model components may also refer to other parts of a model, such as tree leaf values (of a tree model). The controller will update the corresponding physical locations by read, modifying, and/or writing to only the FMUs that contain the weights that are to be changed.

Accordingly, method 700 starts at operation 702, where the host tunes a ML model by updating several weights. At operation 704, the controller receives a list of weights and their offsets in the value from the host. At operation 706, the controller reads only the FMUs from the value that correspond to the offsets passed by the host. At operation 708, the controller modifies and writes to the FMUs that contain the updates in the layer value.

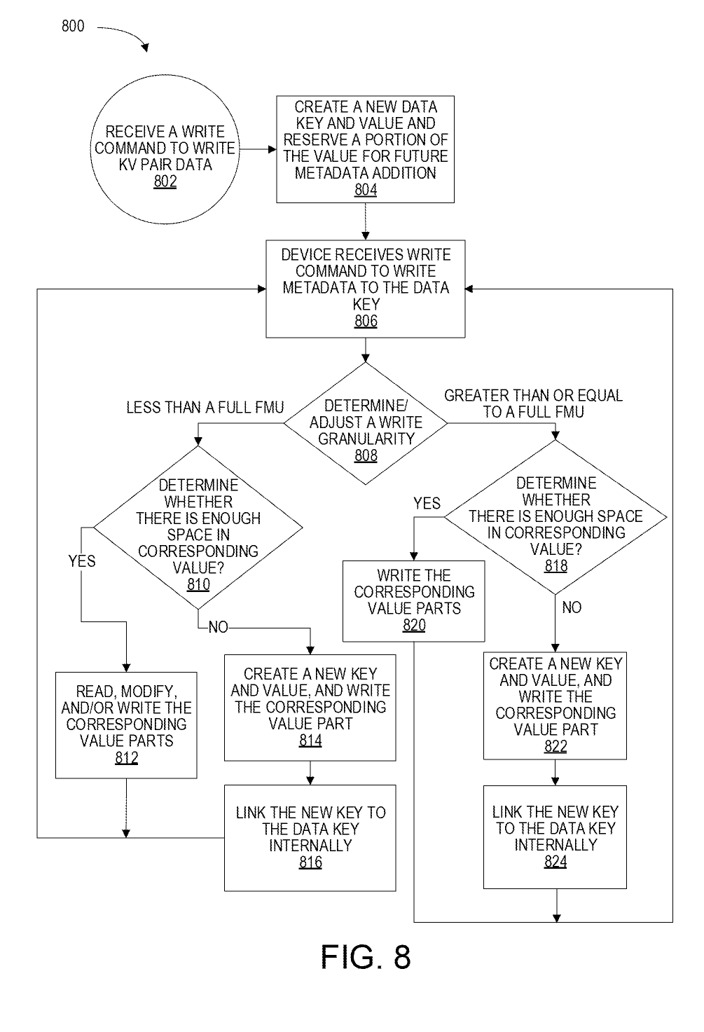

FIG. 8 is a flowchart illustrating a method 800 of a KV metadata storage system, according to certain embodiments. After receiving a write command to write metadata to a certain data key, a controller (e.g. controller 406 of FIG. 4) may first determine the write granularity of the storage device. In some embodiments, the controller is further configured to make a determination of the same before receiving the write command to write metadata. The write granularity may be adjusted based on monitored data storage patterns or usage patterns of the device.

Method 800 starts at operation 802, where the controller receives a write command from the host to write KV pair data. At operation 804, the controller creates a new key and value and reserves a portion of the value for future metadata additions. The value of the KV namespace (i.e., the created key and value) will be greater in size than the KV pair data being stored in order to consider future additions of metadata. For example, the initial KV pair data may take about 10KB, but the value of the KV namespace itself may contain 100KB for the future addition of metadata. Thus, the start of the value will be the 10KB of the source information, but the rest of the value will be reserved for future metadata additions. In some embodiments, the memory is non-volatile memory (e.g., non-volatile memory 110 of FIG. 1). At operation 806, the controller receives a write command from a host (e.g., the host 402 of FIG. 4) to write metadata to a certain data key. At operation 808, the controller may determine or adjust a write granularity based on previous storage or usage patterns of the storage device. The determination whether to adjust the write granularity may also be based on whether there is enough space in the storage device for the write overhead of the excess FMU, as well as the tradeoff in write speed. In some embodiments, the host may indicate to the controller a write granularity size. If the write granularity is less than a full FMU, then at operation 810, the controller determines if there is sufficient space in the corresponding value to append the new piece of metadata. If the write granularity is greater than or equal to a full FMU, then at operation 818, the controller determines if there is sufficient space in the corresponding value to append the new piece of metadata.

After operation 810, if there is sufficient space in the corresponding value, then at operation 812, the controller may read, modify, or write the value internally to non-volatile memory (e.g., non-volatile memory 110 of FIG. 1). It is to be noted that not the entire value needs to be read, but only the part that is to be modified. If there is insufficient space in the corresponding value to append the new piece of metadata, then at operation 814, the controller creates a new key and value, and writes the corresponding value part. At operation 816, the controller internally links the new key to the original data key to which the new key was supposed to be appended to if there was sufficient space in the value.

After operation 818, if there is sufficient space in the corresponding value, then at operation 820 the controller may write the value internally to non-volatile memory (e.g., non-volatile memory 110 of FIG. 1). It is to be noted that not the entire value needs to be read, but only the part that is to be modified. If there is insufficient space in the corresponding value to append the new piece of metadata, then at operation 822, the controller creates a new key and value, and writes the corresponding value part. At operation 824, the controller internally links the new key to the original data key to which the new key was supposed to be appended to if there was sufficient space in the value.

In one embodiment, a data storage device includes a memory device; and a controller coupled to the memory device, wherein the controller is configured to: receive data from a host, wherein the data is key value (KV) pair data; store the data to a KV namespace, wherein: the KV namespace comprises a key and a value; the key addresses the value; the value comprises a plurality of flash management units (FMUs); receive a write command from the host to write a second data to the KV namespace, wherein the write command to write metadata is received subsequent to receipt of the KV pair data; and store the second data to the KV namespace.

The second data is metadata, and a key of the metadata corresponds to a key of the data. The controller is further configured to receive a command from the host to update at least one weight of a machine learning (ML) model. The command further comprises a command to update at least one model component associated with the at least one weight. The controller is further configured to read only the FMUs of the plurality of FMUs that correspond to the at least one model components. The controller is further configured to write and modify the FMUs of the plurality of FMUs that contain the at least one weights.

In another embodiment, a data storage device includes a memory device; and a controller coupled to the memory device, wherein the controller is configured to: receive key value (KV) pair data from a host, wherein: the KV pair data comprises a key and a value; the key addresses the value; the value comprises a plurality of flash management units (FMUs); create a KV namespace, wherein the KV namespace comprises a key and a value; store the KV pair data to the KV namespace; receive a write command from the host to write metadata to the KV namespace, wherein the write command to write metadata is received subsequent to receipt of the KV pair data; and store the metadata to the KV namespace.

A size of the value of the KV pair data is less than a size of the value of the KV namespace. The controller is further configured to reserve a portion of the value of the KV namespace for storing metadata, wherein the portion is a remainder of the value of the KV namespace after storing the KV pair data to the KV namespace. The controller is further configured to determine whether a size of the metadata is less than or equal to the portion. Based on a determination that the size of the metadata is less than or equal to the portion, the controller is further configured to read, modify, or write the metadata to the KV namespace. Based on a determination that the size of the metadata is greater than the portion, the controller is further configured to create a new KV namespace, wherein the new KV namespace comprises a key and a value. Based on a determination that the size of the metadata is greater than the portion, the controller is further configured to store the metadata in the new KV namespace. The controller is further configured to internally link the key of the new KV namespace to the key of the KV namespace. The controller is further configured to determine whether a write granularity is greater than or equal to a full FMU. Based on a determination that the write granularity is greater than or equal to a full FMU, the controller is further configured to write the metadata to the KV namespace. The controller is further configured to adjust a write granularity based on data storage patterns and usage patterns. A size of the value of the KV pair data is between 4 bytes to 4 gigabytes. The memory device is non-volatile memory.

In yet another embodiment, a data storage device includes means to store data; and a controller coupled to the means to store data, wherein the controller comprises: a metadata translation module configured to determine whether there is sufficient space in a value for metadata; and a flash translation layer communicatively coupled to the metadata translation module, and configured to translate KV values or logical block address into physical block addresses; the controller is configured to: receive key value (KV) pair data from a host, wherein: the KV pair data comprises a key and a value; the key addresses the value; the value comprises a plurality of flash management units (FMUs); create a KV namespace, wherein the KV namespace comprises a key and a value; store the KV pair data to the KV namespace; receive a write command from the host to write metadata to the KV namespace, wherein the write command to write metadata is received subsequent to receipt of the KV pair data; store the metadata to the KV namespace; and reserve a portion of the value of the KV namespace for storing metadata, wherein the portion is a remainder of the value of the KV namespace after storing the KV pair data to the KV namespace.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
receive data from a host, wherein the data is key value (KV) pair data;
store the data to a KV namespace, wherein:
the KV namespace comprises a key and a value;
the key addresses the value;
the value comprises a plurality of flash management units (FMUs);
receive a write command from the host to write a second data to the KV namespace, wherein the write command to write metadata is received subsequent to receipt of the KV pair data; and
store the second data to the KV namespace.

2. The data storage device of claim 1, wherein the second data is metadata, and wherein a key of the metadata corresponds to a key of the data.

3. The data storage device of claim 1, wherein the controller is further configured to receive a command from the host to update at least one weight of a machine learning (ML) model.

4. The data storage device of claim 3, wherein the command further comprises a command to update at least one model components associated with the at least one weight.

5. The data storage device of claim 4, wherein the controller is further configured to read only the FMUs of the plurality of FMUs that correspond to the at least one model component.

6. The data storage device of claim 5, wherein the controller is further configured to write and modify the FMUs of the plurality of FMUs that contain the at least one weights.

7. A data storage device, comprising:
a memory device; and
a controller coupled to the memory device, wherein the controller is configured to:
receive key value (KV) pair data from a host, wherein:
the KV pair data comprises a key and a value;
the key addresses the value;
the value comprises a plurality of flash management units (FMUs);
create a KV namespace, wherein the KV namespace comprises a key and a value;
store the KV pair data to the KV namespace;
receive a write command from the host to write metadata to the KV namespace, wherein the write command to write metadata is received subsequent to receipt of the KV pair data; and
store the metadata to the KV namespace.

8. The data storage device of claim 7, wherein a size of the value of the KV pair data is less than a size of the value of the KV namespace.

9. The data storage device of claim 7, wherein the controller is further configured to reserve a portion of the value of the KV namespace for storing metadata, wherein the portion is a remainder of the value of the KV namespace after storing the KV pair data to the KV namespace.

10. The data storage device of claim 9, wherein the controller is further configured to determine whether a size of the metadata is less than or equal to the portion.

11. The data storage device of claim 10, wherein, based on a determination that the size of the metadata is less than or equal to the portion, the controller is further configured to read, modify, or write the metadata to the KV namespace.

12. The data storage device of claim 10, wherein, based on a determination that the size of the metadata is greater than the portion, the controller is further configured to create a new KV namespace, wherein the new KV namespace comprises a key and a value.

13. The data storage device of claim 12, wherein, based on a determination that the size of the metadata is greater than the portion, the controller is further configured to store the metadata in the new KV namespace.

14. The data storage device of claim 13, wherein the controller is further configured to internally link the key of the new KV namespace to the key of the KV namespace.

15. The data storage device of claim 7, wherein the controller is further configured to determine whether a write granularity is greater than or equal to a full FMU.

16. The data storage device of claim 15, wherein, based on a determination that the write granularity is greater than or equal to a full FMU, the controller is further configured to write the metadata to the KV namespace.

17. The data storage device of claim 16, wherein the controller is further configured to adjust a write granularity based on data storage patterns and usage patterns.

18. The data storage device of claim 7, wherein a size of the value of the KV pair data is between 4 bytes to 4 gigabytes.

19. The data storage device of claim 7, wherein the memory device is non-volatile memory.

20. A data storage device, comprising:
means to store data; and
a controller coupled to the means to store data, wherein the controller comprises:
a metadata translation module configured to determine whether there is sufficient space in a value for metadata; and
a flash translation layer communicatively coupled to the metadata translation module, and configured to translate KV values or logical block address into physical block addresses;
the controller is configured to:
receive key value (KV) pair data from a host, wherein:
the KV pair data comprises a key and a value;
the key addresses the value;
the value comprises a plurality of flash management units (FMUs);
create a KV namespace, wherein the KV namespace comprises a key and a value;
store the KV pair data to the KV namespace;
receive a write command from the host to write metadata to the KV namespace, wherein the write command to write metadata is received subsequent to receipt of the KV pair data;
store the metadata to the KV namespace; and
reserve a portion of the value of the KV namespace for storing metadata, wherein the portion is a remainder of the value of the KV namespace after storing the KV pair data to the KV namespace.
